(19) United States
(12) Patent Application Publication
(10) Pub. No.: US 2011/0197210 A1
(43) Pub. Date: Aug. 11, 2011

(54) OPTICAL DISC DRIVE

(75) Inventors: Tatsuya YAMASAKI, Hitachinaka (JP); Yoshiaki Yamauchi, Omitama (JP); Nozomu Harada, Kawasaki (JP); Sojiro Kirihara, Kawasaki (JP); Ikuo Nishida, Ebina (JP)

(73) Assignees: Hitachi Consumer Electronics Co., Ltd.; Hitachi-LG Data Storage, Inc.

(21) Appl. No.: 13/022,769

(22) Filed: Feb. 8, 2011

(30) Foreign Application Priority Data
Feb. 8, 2010 (JP) 2010-025379

(51) Int. Cl. G11B 17/056

(52) U.S. Cl. 720/604; G9B/17.013

(57) ABSTRACT

An optical disc drive with low vibration and low noise without risk of damage to components and injury caused by ejection of the disc tray with the rotating optical disc from a housing is provided by simple structure. In a disc-tray scheme of the optical disc drive, a brake member attached to the inside of the housing is placed to be in contact with the optical disc sliding thereon when the disc tray is in a predetermined position except the disc recording/reproducing position and the disc loading/unloading position, and to be connected to the disc tray when the disc tray is in the disc recording/reproducing position.

### BACKGROUND OF THE INVENTION

(i) Field of the Invention

This invention relates to an optical disc drive with reduced vibration.

(ii) Described of the Related Art

In recent years, CDs, DVDs and optical discs as typified by BD (Blu-ray Disc) have tended to have increasingly increased storage capacity. A BD can store 25 GB of data in a single layer on a single side or 50 GB of data in dual layers, and the number of layers is on the increase.

With this increase, for implementing high-speed reading or high-speed writing of data, an optical disc drive which records/reproduces data on/from the optical disc is required to increase the disc rotation speed.

In an optical disc drive of a disc tray scheme involving fast rotation, in some cases, such as an emergency shutdown of the optical disc drive or the like, a disc tray may be ejected from the housing before the rotation of the optical disc is completely stopped (hereinafter referred to as “residual rotation”). In this event, the rotating optical disc may possibly injure the user, damage the optical disc surface and the like, possibly raising safety concerns. Also, there is a disadvantage of vibrations of the disc tray from the high-speed rotation of the optical disc as will be understood.

As structure of preventing such vibrations of the disc tray, for example, JP-A No. 2008-117432 discloses the structure of using a pressing force of an elastic member attached in a direction perpendicular to the direction of sliding a disc tray to hold down the disc tray and a rack slide which is means for sliding the disc tray, which is capable of suppressing the vibrations of the disc tray.

JP-A No. H9-213000 discloses the structure of place a brake member into contact with the top surface of an optical disc in order to stop the residual rotation.

In addition, JP-A No. H9-212999 discloses the structure of placing a brake member into contact with a portion of the outer periphery of an optical disc in order to stop the residual rotation.

In optical disc drives as described above, an increase in mechanical vibrations with an increase in rotation speed of the optical disc adversely affects performance of writing/reading the recording surface of a high-density optical disc, resulting in a disadvantage of increased vibration noise.

In particular, in an optical disc drive of a disc tray scheme in which a section on which a driving mechanism for an optical disc and a recording/reproducing mechanism are mounted (hereinafter referred to as a “disc tray”) can be slid in and out of the accommodation area of the optical disc drive, a gap is provided between adjacent components for smooth sliding movement of the disc tray sliding mechanism.

Because of this, a vibration transmission path for transmitting the vibrations of the disc tray to other components for vibration dissipation cannot be adequately ensured, thus increasing the vibrations. Also, the adjacent components come into collision with each other due to the vibrations to produce chattering noise. If an increase in vibrations of the disc tray causes occurrence of chattering noise, then it creates an increase in noise and a sense of discomfort during the operation.

That is, a problem specific to the disc tray scheme is vibration generated by vibrations of the disc tray itself generated with the rotation of the disc. The vibrations of the disc tray itself induce vibrations in an actuator itself mounted on the optical pickup, greatly affecting the performance of the optical disc drive. Also, the increased vibrations of the disc tray make the adjacent components come into collision with each other to produce chattering noise. To address this, in general, vibration isolation measures are taken to transmit the vibrations of the disc tray to a top case and the like for lessening of vibrations. However, since a gap is provided between components of sliding rails for smooth sliding of the disc tray, an adequate vibration transmission path is not easily ensured (such problems do not arise in a slot scheme which does not use a disc tray).

In an optical disc drive of a disc tray scheme, in the event of an emergency shutdown of the optical disc drive or the like, a disc tray may be ejected from the housing before the rotation of the optical disc is completely stopped. This may possibly cause injury, damage to a component or the like, resulting in high risk.

JP-A No. 2008-117432 discloses the structure of pressing a drawer (disc tray) with a pressing spring as measures against the aforementioned problems associated with the vibrations from the disc tray, but does not disclose measures for preventing residual rotation of the optical disc. JP-A Nos. H9-213000 and H9-212999 disclose the prevention of the residual rotation of the optical disc, but does not disclose the prevention of the vibrations of the disc tray.

### SUMMARY OF THE INVENTION

The present invention has been made in view of the above circumstances and provides an optical disc drive capable of preventing residual rotation of an optical disc from causing injury, damage to the surface of the optical disc, and the like and also of minimizing vibrations of a disc tray.

To provide such an optical disc drive, accordingly, an optical disc drive comprises: a housing including a top cover and a bottom cover; a brake member fixed onto an inner wall face of the housing;

a spindle motor for loading and rotating an optical disc; a pickup for reproducing/recording information from/to a recording surface of the optical disc; and a disc tray mounted with the spindle motor and the pickup, and sliding between a disc recording/reproducing position inside the housing and a disc loading/unloading position outside the housing. In the optical disc drive, the brake member is placed to slide in contact with the optical disc when the disc tray is in a predetermined position except for the disc recording/reproducing position and the disc loading/unloading position, and to be connected to a part of the disc tray when the disc tray is in the disc recording/reproducing position.

Preferably, the brake member may be connected to a protrusion provided on a part of the disc tray.

Preferably, a protrusion may be provided on a part of the disc tray and has an inclined face, and the brake member is connected to the inclined face.

Preferably, when the brake member is in contact with the optical disc sliding thereon, the brake member may be in contact with a label side of the optical disc, and press the label side in a direction perpendicular to the label side.

Preferably, when the brake member is connected to the disc tray, the brake member may be placed in a position of pressing the disc tray in a direction parallel to a rotation axis of the optical disc.

Preferably, when the brake member is connected to the disc tray, the brake member may be placed in a position that the brake member presses the disc tray in a direction parallel to a label side of the optical disc.

Preferably, when the brake member is connected to the disc tray, the brake member may be placed in a position of pressing the disc tray in a direction parallel to a rotation axis of the optical disc, and pressing the disc tray in a direction parallel to a label side of the optical disc.

Preferably, when the brake member is connected to the disc tray, at least a part of a connecting face of the brake member may be formed in a slope shape.

According to the present invention, an optical disc drive capable of minimizing vibrations of a disc tray in addition to preventing injury, damage to the optical-disc surface and the like from being caused by residual rotation of the optical disc.

### BRIEF DESCRIPTION OF THE DRAWINGS

Embodiments of the present invention will be described in detail based on the following drawings, wherein:

FIG. 1 is an exploded perspective view illustrating the structure of a general optical disc drive;

FIGS. 2A, 2B are schematic diagrams illustrating component layout in a general optical disc drive;

FIGS. 3A, 3B are schematic diagram of an optical disc drive according to an embodiment of the present invention;

FIGS. 4A, 4B, 4C are schematic diagram of an optical disc drive according to an embodiment of the present invention; and

FIGS. 5A, 5B, 5C are schematic diagram of an optical disc drive according to another embodiment of the present invention.

### DETAILED DESCRIPTION OF THE INVENTION

When the disc tray is ejected after unlocking, the spindle motor is controlled to stop its rotation, so that the rotation of an optical disc is stopped. However, in the event of ejecting the disc tray (drawing the disc tray out) when an abnormal end occurs due to power supply interruption or the like as described earlier, the control of stopping the rotation of the optical disc is not performed. Then, in some cases, the optical disc rotating by inertia is ejected from the housing.

In this event, the optical disc rotating at high speed may possibly injure a user' s finger and/or be damaged.

To address this, the inventors of the present invention has made various studies for use of a pad for not only forcibly stopping the rotation of an optical disc (hereinafter referred to as a “brake member”) described in JP-A Nos. H9-213000 and H9-212999, but also lessening the vibrations of the disc tray. As a result, the following embodiments can be considered.

An embodiment of the present invention will be described below with reference to the accompanying drawings.

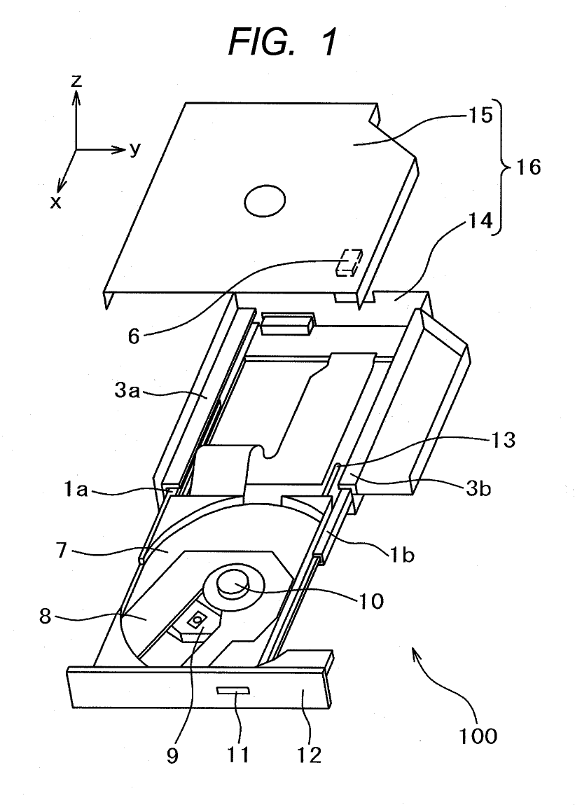

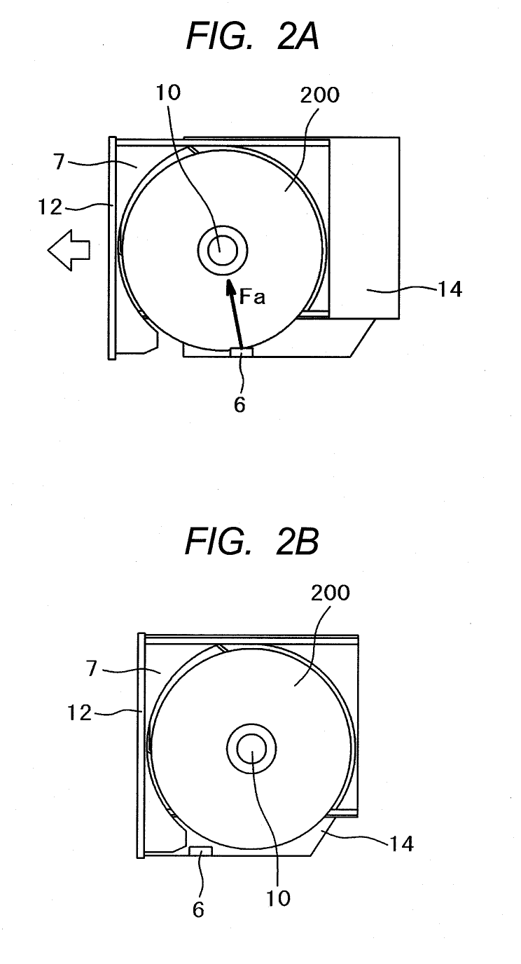

Prior to the description of the embodiment of the present invention, the structure of general optical disc drives is described with reference to FIGS. 1, 2A, 2B.

FIG. 1 is an exploded perspective view of a general optical disc drive. FIGS. 2A, 2B are schematic diagrams illustrating the component layout of the general optical disc drive. FIG. 2A is a top view of the optical disc drive during the process of ejecting a disc tray 7 from a housing. FIG. 2B is a top view of the optical disc drive with the disc tray 7 placed in the housing.

Coordinates are defined such that the direction of sliding a disc tray 7 from the inside of the housing 16 to the outside is set as a positive x-axis direction, and the direction extending from a bottom case 14 toward a top cover 15 at right angles to the surface of an optical disc 200 is set as a positive z-axis direction.

In FIG. 1, the optical disc drive 100 includes a housing 16 including a combination of the bottom caver 14 and the top cover 15 which are each formed of a thin metal plate by press-forming. The disc tray 7 is supported through rack slides la, lb by guide rails 3a, 3b attached to inner sides of the bottom cover 14. The rack slides 1a, 1b and the disc tray 7 are slidable in the rail direction of the guide rails 3a, 3b. A brake member 6 is stuck to an inner wall face of the top cover 15. The brake member 6 is formed of an elastic member such as a rubber, sponge or the like, and situated in a position facing the label side of the optical disc 200 in the drawings. When the process of writing/reading the optical disc 200 is terminated and the disc tray 7 is ejected, the brake member 6 comes into contact with the surface of the optical disc 200 to forcibly stop the rotation of the optical disc 200.

The disc tray 7 has attached to it a spindle motor 10 for rotating an optical disc loaded thereon, and a unit mechanism 8 through three insulators (not shown) . The unit mechanism 8 has mounted on it a pickup 9 for reproducing information from the recording surface of the optical disc or recording information onto the recording surface. A bezel 12 is attached to the front of the disc tray 7. The bezel 12 serves as a front lid of the housing 16 when the disc tray 7 is placed in the housing 16. A switch 11 is attached to the front face of the bezel 12 for opening/closing the disc tray 7.

A disc-tray thrust mechanism 13 is attached to the disc tray 7. The disc-tray thrust mechanism 13 can be tucked into a forward portion. When the disc-tray thrust mechanism 13 is tucked, an elastic body (not shown) in the disc-tray thrust mechanism 13 contracts to be shorter than its natural length.

Reproduction of information recorded on the optical disc or record of information are performed when the disc tray 7 is housed in a predetermined position in the housing 16. During the reproducing/recording process, the disc tray 7 is inhibited from being ejected from the housing 16 by a lock mechanism (not shown). At this stage, the disc-tray thrust mechanism 13 is tucked by the bottom cover 14 and fixed while the elastic body in the disc-tray thrust mechanism 13 is contracting.

In FIG. 2A, for loading/unloading the optical disc 200 on/from the spindle motor 10, the disc tray 7 should be ejected from the housing 16. For this ejection, the switch 11 mounted on the bezel 12 is pushed. Alternatively, a CPU (Central Processing Unit, not shown) detects a signal representative of an ejection instruction transmitted from an external connected device (not shown) , and then outputs an unlocking instruction to the lock mechanism to unlock.

FIG. 1 shows the structure of allowing the brake member 6 to come into contact with the label side of the optical disc to apply a brake as described in JP-A No. H9-213000. FIGS. 2A, 2B show the structure of allowing the brake member 6 to come into contact with a portion of an outer peripheral edge of the optical disc 200 to stop the optical disc 200 as described in JP-A No. H9-2129999.

When the lock mechanism is unlocked, as shown in FIG. 2A, the disc tray 7 is pushed out of the housing 16 in the direction shown by the arrow by a force generated when the contracting elastic body in the disc-tray push-out mechanism 13 returns to its natural length. At this time, the outer peripheral edge of the optical disc 200 comes into contact with the brake member 6, so that the rotation of the optical disc is stopped. This is because the brake member 6 presses against the edge of the optical 200 toward the Fa direction shown by the arrow.

In FIG. 2B, for moving the disc tray 7 from the outside of the housing 16 to the inside of the housing 16, when the disc tray 7 is manually moved to an optical-disc recording/reproducing position within the housing 16, a latch mechanism (not shown) actuates the lock mechanism to lock the movement of the disk tray 7. At this stage, the disc tray 7 is moved while the outer peripheral edge of the optical disc 200 is in contact with the brake member 6, but the optical disc 200 is locked in a position without interference with its rotation after passing through the brake member 6. In the recording/reproducing operation on the optical disc 200, the spindle motor 10 is driven to rotate the optical disc 200 at high speed.

At this stage, upon the fast rotation of the optical disc 200, whirl vibrations at the first order of disc-rotation occur because of a specific unbalance due to a dimension error of the optical disc 200 and/or a specific unbalance due to a misalignment between the rotation axes of the optical disc and the spindle motor 10 which occurs when the optical disc is placed on the spindle motor 10.

If the disc tray 7 is ejected from the housing 16 while the optical disc which has rotated at high speed in the recording/reproducing process is rotating residually even after the termination of the recording/reproducing process, a person' s finger may possibly touch the rotating optical disc and be injured, or alternatively may possibly touch a component adjacent to the housing 16 or the like and damage the optical disc and/or drive components, which are unwanted.

In this manner, as illustrated in FIG. 2A, the brake member 6 attached to a general optical disc drive is effective only for the sliding process of the disc tray 7. However, as illustrated in FIG. 2B, since the brake member 6 is provided in a position where the brake member 6 is out of contact with the optical disc and other components during the disc operation, the brake member 6 contributes not at all to prevent vibrations of the disc tray. To address this, the inventors of the present inventions have thought to impart, to the brake member, the function of preventing vibrations of the disc tray in addition to the function of stopping the rotation on the disc tray.

### First Embodiment

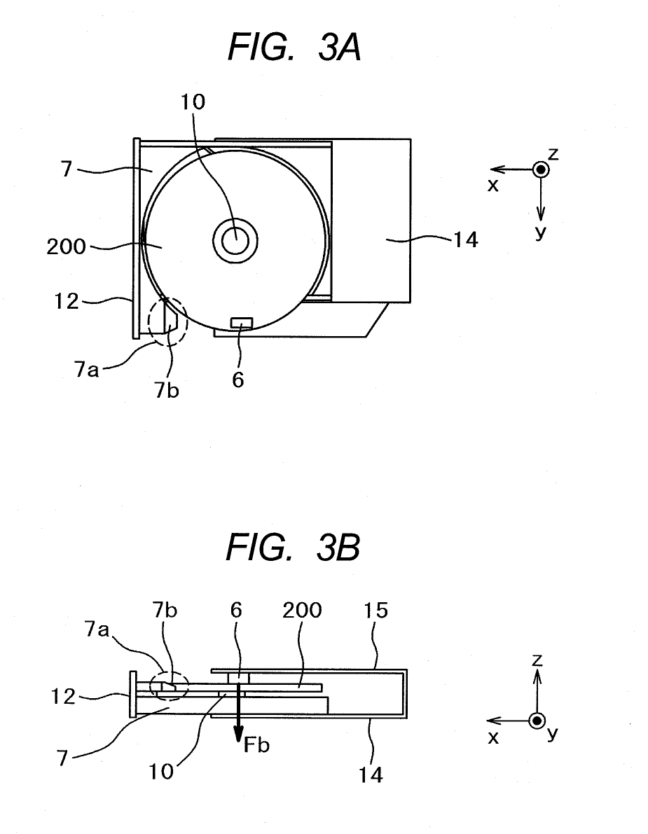

FIGS. 3A, 3B are schematic diagrams illustrating an optical disc drive according to an embodiment of the present invention. FIG. 3A is a top view of the optical disc drive according to the embodiment. FIG. 3B is a cross-sectional view of the optical disc drive.

In FIGS. 3A, 3B, the disc tray 7 is covered with the bottom cover 14 and the top cover 15 which are formed of thin metal plate by press-forming. The disc tray 7 is capable of sliding in the rail direction of the guide rails 3a, 3b shown in FIG. 1.

The spindle motor 10 is mounted to the disc tray 7 for loading and rotating an optical disc. On the front of the disc tray 7, the bezel 12 is attached as a front lid of the housing 16 when the disc tray 7 is placed in the housing 16. When the disc tray 7 is housed in a predetermined position within the housing 16, information is reproduced from the optical disc 200 or recorded onto the optical disc 200.

The brake member 6 is bonded to an inner wall face of the top cover 15 as described earlier. However, a difference from the case described in FIG. 1 is that the position of the brake member 6 when the disc tray 7 is housed in the housing 16 is a position where the brake member 6 presses a part of the disc tray 7, and the brake member 6 is in a position in contact in the direction of pressing the surface of the optical disc 200 in the Fb direction as illustrated in FIG. 3B while the disc tray 7 is ejected. A protrusion 7 is provided on a portion of the disc tray 7 to allow the brake member 6 to be connected to it. The protrusion 7 has an inclined face 7b.

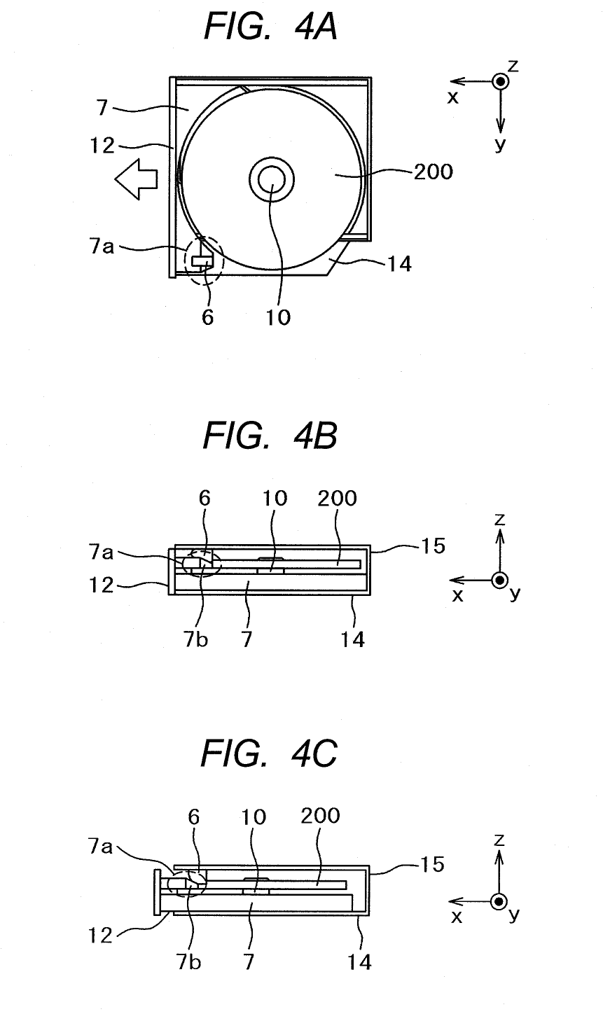

FIGS. 4A, 4b, 4C illustrate an optical disc drive according to the embodiment. FIG. 4A is a top view illustrating the disc tray housed. FIG. 4B is a cross-sectional view of FIG. 4A. FIG. 4C is a cross-sectional view of the disc tray ejected.

In FIG. 4A, the brake member 6 is in contact with the upper surface (label side) of the optical disc 200 during passage through the brake member 6, and then the brake member 6 is connected to the protrusion 7a of the disc tray 7 while the disc tray 7 is completely closed. The brake member 6 is compressed between the top cover 15 and the protrusion 7a of the disc tray 7 as illustrated in FIG. 4B while the disc tray 7 is completely housed.

In the embodiment, the inclined face 7b is formed on the protrusion 7a of the disc tray 7. The inclined face 7b can prevent the brake member 6 from turning and detaching because the brake member 6 is abutted on the inclined face 7b when the brake member 6 and the protrusion 7a are connected to each other. That is, if the inclined face 7b is not provided, the protrusion 7a applies a pressure to the contact face of the brake member 6 in the same direction, so that the brake member 6 may be possibly peeled away from the top cover 15.

FIG. 4C illustrates the disc tray 7 unlocked and ejected. In this state, the brake member 6 is separated from the protrusion 7a and then comes into contact with the surface (label side) of the optical disc 200, thus being able to stop the rotation of the optical disc 200.

In this manner, according to the embodiment, it is possible to form a vibration transmission path for dissipating vibrations of the disc tray 7 arising from whirl vibrations at the first order of rotation of the optical disc, through the brake member 6 to the housing 16 even during the disc operation, resulting in a reduction in vibrations of the disc tray 7.

In short, two functions of stopping the rotation of an optical disc during the sliding of the disc tray 7 and of reducing the vibration of the disc tray 7 during the optical-disc operation can be implemented by single simple structure. Accordingly, structure simplification makes reductions in cost, size and weight possible.

In this manner, according to the embodiment, a force acting in the in-plane direction of the disc is not generated while the brake member 6 is in contact with the optical disc sliding thereon, and the use of the brake member 6 inhibits an increase in deviation of the center of gravity of the optical disc with respect to the center axis of the spindle motor 10.

It should be understood that a plurality o brake members 6 may be provided.

### Second Embodiment

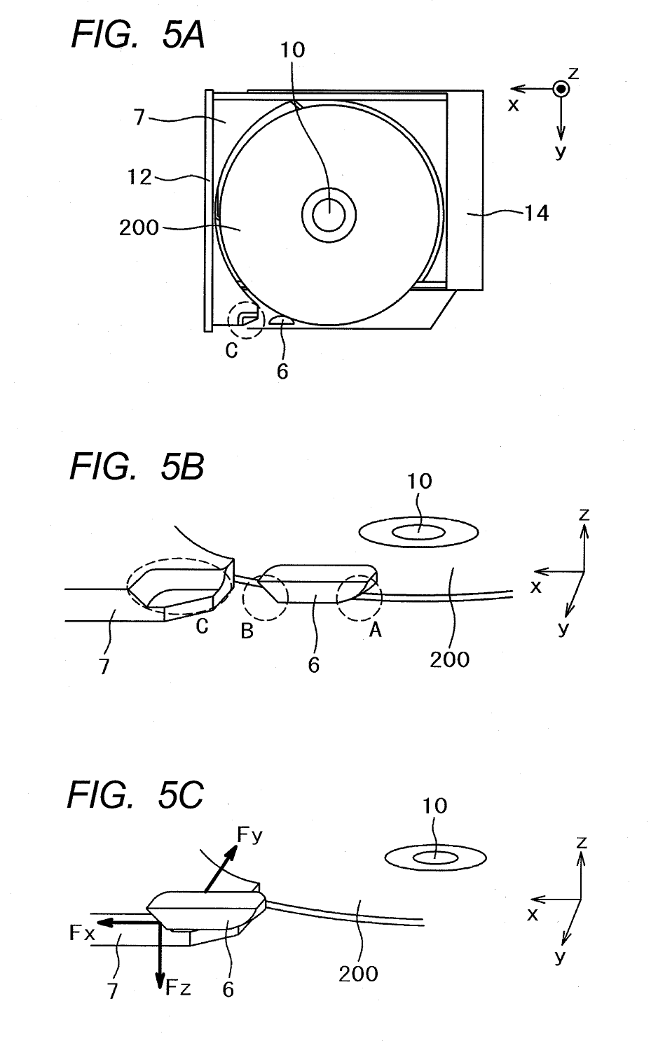

FIGS. 5A, 5b, 5C illustrate an optical disc drive according to another embodiment. FIG. 5A is a top view illustrating the disc tray while being ejected from a housing. FIG. 5B is an enlarged perspective view of the disc tray and a brake member. FIG. 5C is a perspective view of the disc tray in contact with the brake member.

Coordinates are defined such that the direction of sliding the disc tray 7 from the inside of the housing 16 to the outside is set as a positive x-axis direction, and the direction extending from the bottom case 14 toward the top cover 15 at right angles to the surface of an optical disc is set as a positive z-axis direction.

In FIGS. 5A, 5B, 5C, the brake member 6 according to the embodiment has a slope-shaped brake-member rear end A and a slope-shaped brake-member front end B. The brake member rear end A is a portion with which the optical disc comes into contact and slides at the beginning when the disc tray 7 is about to be slid from the inside of the housing 16 to the outside. The brake-member front end B is a portion with which the optical disc comes into contact and slides at the beginning when the disc tray 7 is slid from the outside of the housing 16 to the inside. Because of this design, the brake member 6 can start smoothly sliding on the label side of the optical disc without catch on the side edge of the optical disc.

In addition, a disc-tray face C of a portion of the disc tray 7 to which the brake member 6 is connected when the disc tray 7 is slid into the housing 16 is formed in a slope shape engaged with the slope shape of the brake member 6 as illustrated in FIG. 4B.

In the employment of this structure, if the force of the brake member 6 pressing the disc tray during the optical-disc operation is decomposed into x-, y- and z-axis directions, directions Fx, Fy, Fz are obtained as shown by the arrows in FIG. 5C. That is, the pressing force acts in the directions of all the x, y and z axes, so that the effect of vibration reduction is beneficial in all the x-, y- and z-axis components of the vibration of the disc tray 7 during the optical-disc operation.

The disc tray 7 is provided with a certain gap from the peripheral components such as the rack slides 1a, 1b, the guide rails 3a, 3b and the like shown in FIG. 1 in order to achieve smooth sliding. However, whirl vibrations at the first order of disc-rotation as described in the first embodiment occur when a recording/reproducing operation is performed on the optical disc. Because of this, the gap between the disc tray 7 and the peripheral components causes contact vibrations, or so-called rattling vibrations, which in turn produces chattering noise, resulting in significant degradation in noise performance.

However, employing the structure according to the embodiment makes it possible to narrow the gap between the rack slide 1(a, b) and the peripheral components in the direction of the pressing force of the brake member 6 during the disc operation (reduction in backlash and play). In consequence, an optical disc drive without rattling vibrations and chattering noise arising from the presence of a gap between components is provided.

The whole contact regions of the brake member 6 and the disc tray 7 are not necessarily formed in the slope shape, and part of them may be formed in a slope shape. The structure according to the embodiment can be employed in a plurality of sites.

In this manner, according to the present invention, a brake member mounted in an optical disc drive is in contact with an optical disc sliding thereon during the process of sliding a disc tray from the inside of a housing to the outside, and the brake member is connected to the disc tray while the disc tray is in the disc recording/reproducing position. Thus, an optical disc drive with low vibration and low noise without risk of damage to components and injury which are caused by ejection of the disc tray with the rotating optical disc loaded thereon from the housing can be provided with simple structure.

It should be understood by those skilled in the art that various modifications, combinations, sub-combinations and alterations may occur depending on design requirements and other factors insofar as they are within the scope of the appended claims of the equivalents thereof.

What is claimed is:

1. An optical disc drive, comprising:
a housing including a top cover and a bottom cover;
a brake member fixed onto an inner wall face of the housing;
a spindle motor for loading and rotating an optical disc;
a pickup for reproducing/recording information from/to a recording surface of the optical disc; and
a disc tray mounted with the spindle motor and the pickup, and sliding between a disc recording/reproducing position inside the housing and a disc loading/unloading position outside the housing,
wherein the brake member is placed to slide in contact with the optical disc when the disc tray is in a predetermined position except for the disc recording/reproducing position and the disc loading/unloading position, and to be connected to a part of the disc tray when the disc tray is in the disc recording/reproducing position.

2. The optical disc drive according to claim 1, wherein
the brake member is connected to a protrusion provided on a part of the disc tray.

3. The optical disc drive according to claim 1, wherein
a protrusion is provided on a part of the disc tray and has an inclined face, and the brake member is connected to the inclined face.

4. The optical disc drive according to claim 1, wherein
when the brake member is in contact with the optical disc sliding thereon, the brake member is in contact with a label side of the optical disc, and presses the label side in a direction perpendicular to the label side.

5. The optical disc drive according to claim 1, wherein
when the brake member is connected to the disc tray, the brake member is placed in a position of pressing the disc tray in a direction parallel to a rotation axis of the optical disc.

6. The optical disc drive according to claim 1, wherein
when the brake member is connected to the disc tray, the brake member is placed in a position that the brake member presses the disc tray in a direction parallel to a label side of the optical disc.

7. The optical disc drive according to claim 1, wherein
when the brake member is connected to the disc tray, the brake member is placed in a position of pressing the disc tray in a direction parallel to a rotation axis of the optical disc, and pressing the disc tray in a direction parallel to a label side of the optical disc.

8. The optical disc drive according to claim 1, wherein
when the brake member is connected to the disc tray, at least a part of a connecting face of the brake member is formed in a slope shape.
